(19) United States
(12) Patent Application Publication
(10) Pub. No.: US 2023/0313017 A1
(43) Pub. Date: Oct. 5, 2023

(54) THERMALLY CONDUCTIVE COMPOSITION

(71) Applicant: Resonac Corporation, Tokyo (JP)

(72) Inventors: Hajime FUNAHASHI, Tokyo (JP); Hikaru Satoh, Tokyo (JP); Hajime Yukutake, Tokyo (JP); Ikue Kobayashi, Tokyo (JP); Takeshi Iemura, Tokyo (JP)

(73) Assignee: Resonac Corporation, Tokyo (JP)

(21) Appl. No.: 18/127,720

(22) Filed: Mar. 29, 2023

(30) Foreign Application Priority Data
Mar. 30, 2022 (JP) 2022-056755

(51) Int. Cl. C09K 5/14; C08L 83/04

(52) U.S. Cl. CPC C09K 5/14; C08L 83/04; C08L 2205/025; C08L 2203/20; C08L 2201/08

(57) ABSTRACT

A thermally conductive composition contains a resin composition and a thermally conductive filler, wherein the resin composition contains a liquid silicone resin having a viscosity ranging from 20 mPa·s to 200,000,000 mPa·s at 25° C. as measured according to JIS Z8803:2011 and a polysiloxane compound having at least one hydroxy group not directly bound to a silicon atom at an end, and having no vinyl group; the mass ratio of the liquid silicone resin to the polysiloxane compound [the liquid silicone resin/the polysiloxane compound] is 50/50 or more and less than 90/10, the content of the thermally conductive filler ranges from 300 parts by mass to 5,000 parts by mass with respect to 100 parts by mass of the resin composition, and a cured product of the thermally conductive composition has a thermal conductivity of 1.0 W/mk or more as measured according to ISO22007-2.

### FIELD OF THE INVENTION

The present invention relates to a thermally conductive composition.

### BACKGROUND OF THE INVENTION

The removal of heat from heating elements has been a problem in various fields in recent years. The removal of heat from particularly exothermic electronic devices such as electronic instruments, personal computers, automotive engine control units (ECUs) and batteries is an important problem. The heating value of an exothermic part has been recently increased and thus a heat dissipation material with high thermal conductivity has been used as a countermeasure against heat.

Examples of a heat dissipation material that is in use include shaping materials such as a heat dissipation sheet produced by adding a thermally conductive filler to an elastomer, and casting materials such as a material referred to as a potting material having thermal conductivity enhanced by the addition of a thermally conductive filler to a silicone material. These materials have relatively high thermal conductivity, and the use of these materials enables to miniaturize a heat dissipator and enables to reduce the size and weight of an electronic device, so that these materials are actively used. However, due to increases in heating values of heating elements in recent years, a heat dissipation material with even higher thermal conductivity is required.

Various techniques have been conventionally proposed to solve these problems. For example, PTL1 proposes a multi-part condensation curable thermally conductive silicone adhesive composition containing polysiloxane having hydroxy groups at both ends, which are directly bound to silicon atoms, polysiloxane having trialkoxysilyl groups at both ends, at least one condensation catalyst selected from the group of a titanate and/or a zirconate, and a thermally conductive filler.

Further, PTL2 proposes a thermally conductive silicone composition containing organopolysiloxane as a base polymer and thermally conductive fillers, in which alumina surface-treated with a silicone having an alkoxy group at one end and an aluminum nitride are used in combination, and a cured product thereof. Further PTL2 demonstrates that the thermally conductive silicone composition has thermal conductivity as high as 5 W/mk, and proposes heat dissipation materials containing an addition reaction curable-type silicone resin, a condensation reaction curable-type silicone resin, an organic peroxide curable-type silicone resin, and a silicone resin in any form such as grease.

Furthermore, PTL3 proposes heat dissipation materials containing an addition reaction curable-type silicone resin, a condensation reaction curable-type silicone resin, grease, etc., which contain various fillers surface-treated with a silicone resin having an alkoxy group at one end or a silicone resin having alkoxy groups at both ends.

### CITATION LIST

### Patent Literature

PTL1: Japanese Translation of PCT International Application Publication No. 2019-527276

PTL2: Japanese Patent Laid-Open No. 2017-210518

PTL3: U.S. Patent Application Publication No. 2018/230172

### SUMMARY OF THE INVENTION

A heat dissipation material is required to have high thermal conductivity and to exhibit low viscosity immediately after production in view of workability at the time of shaping and casting, etc. Further, from the same viewpoint, a heat dissipation material is desired to have an appropriate reaction rate, and excellent storability. Furthermore, the cured product of a heat dissipation material is required to be not too hard and have appropriate hardness, so as to avoid applying a load to a substrate, a heater element, etc., to the extent possible.

Meanwhile, according to the method of PTL1, a thermally conductive filler is pretreated with trialkoxysilane. Pretreatment with a trialkoxysilane can lower the viscosity of a multi-part condensation-curable thermally conductive silicone adhesive composition before curing, but the method of PTL 1 has been problematic that the trialkoxysilane also serves as a cross-linking agent, so that the reaction proceeds abnormally fast and the cured product may have abnormally high hardness.

According to the method of PTL2, a silicone resin having an alkoxy group at one end is used as a surface-treating agent for a thermally conductive filler. In the silicone resin, the alkyl group portion of the silane agent is a polydimethylsiloxane chain. By using the silicone resin, the viscosity of the thermally conductive silicone composition can be lowered. However, when a condensation reaction-curable silicone resin is used, the condensation reaction-curable silicone resin also acts as a cross-linking agent, the method of PTL2 has been problematic that the reaction proceeds abnormally fast, the storability is poor, and the cured product may have abnormally high hardness.

As in the method of PTL2, the method of PTL3 has been also problematic in that since a silicone resin having an alkoxy group is used as a surface-treating agent for various fillers (thermally conductive fillers), when a condensation reaction curable-type silicone resin is used, the reaction proceeds abnormally fast, the storability is poor, and the cured product may have abnormally high hardness.

The present invention has been made in view of such circumstances, and an object thereof is to provide a thermally conductive composition having high thermal conductivity, exhibiting low viscosity immediately after production, and making it possible to obtain a cured product having appropriate hardness.

As a result of diligent studies in order to solve the above problems, the inventors have found that the problems can be solved by the invention below.

Specifically, the present disclosure relates to:

[1] A thermally conductive composition containing a resin composition and a thermally conductive filler, wherein
the resin composition contains a liquid silicone resin having a viscosity ranging from 20 mPa·s to 200,000,000 mPa·s at 25° C. as measured according to JIS Z8803:2011 and a polysiloxane compound having at least one hydroxy group not directly bound to a silicon atom at an end, and having no vinyl group,

the mass ratio of the liquid silicone resin to the polysiloxane compound [the liquid silicone resin/the polysiloxane compound] is 50/50 or more and less than 90/10,

the content of the thermally conductive filler ranges from 300 parts by mass to 5,000 parts by mass with respect to 100 parts by mass of the resin composition, and

a cured product of the thermally conductive composition has a thermal conductivity of 1.0 W/mk or more as measured according to ISO22007-2.

[2] The thermally conductive composition according to [1] above, wherein the polysiloxane compound has two or more hydroxy groups not directly bound to a silicon atom, at one of the ends of the main chain constituting the polysiloxane compound.
[3] The thermally conductive composition according to [1] or [2] above, wherein the polysiloxane compound is represented by general formula (1) below:

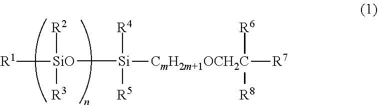

wherein R¹ is an alkyl group having 1 to 18 carbon atoms or a phenyl group, R² to R⁵ are each independently an alkyl group having 1 to 18 carbon atoms or a phenyl group, R⁶ and R⁸ are each independently a hydrogen atom, a hydroxymethyl group, or a hydroxyethyl group, R⁷ is an alkyl group having 1 to 3 carbon atoms, a hydroxy group, or a phenyl group, n is 5 to 250 and m is 1 to 20, and when there are a plurality of R² and R³ above, the plurality of R² and R³ are the same or different.
[4] The thermally conductive composition according to [3] above, wherein R¹ is an alkyl group having 1 to 18 carbon atoms.
[5] The thermally conductive composition according to [3] or [4] above, wherein R⁶ and R⁸ above are each independently a hydroxymethyl group or a hydroxyethyl group.
[6] The thermally conductive composition according to any one of [1] to [5] above, wherein the liquid silicone resin is at least one selected from the group consisting of an addition reaction curable-type silicone resin, a condensation reaction curable-type silicone resin, and an organic peroxide curable-type silicone resin.
[7] The thermally conductive composition according to any one of [1] to [6] above, wherein the content of the thermally conductive filler is 3,000 parts by mass or less with respect to 100 parts by mass of the resin composition.
[8] The thermally conductive composition according to any one of [1] to [7] above, wherein the liquid silicone resin has a viscosity of 10,000,000 mPa·s or less at 25° C. as measured according to JIS Z8803:2011.
[9] The thermally conductive composition according to any one of [1] to [8] above, which is used for a semiconductor package.
[10] A method for producing a thermally conductive composition, wherein the thermally conductive composition according to any one of [1] to [9] above is obtained by mixing the liquid silicone, the polysiloxane compound, and the thermally conductive filler.
[11] A method for using a thermally conductive composition, comprising mixing a liquid silicone, a polysiloxane compound and a thermally conductive filler, and then filling a container with the mixture for use.
[12] A method for using a thermally conductive composition, comprising filling a container with a liquid silicone, a polysiloxane compound, and a thermally conductive filler, respectively, for use.

### Advantageous Effect of Invention

According to the present invention, a thermally conductive composition having high thermal conductivity, exhibiting low viscosity immediately after production, and making it possible to obtain a cured product having appropriate hardness can be provided.

### DETAILED DESCRIPTION OF THE INVENTION

The terms and notation used herein are as defined below.

The term “viscosity of a liquid silicone resin at 25° C.” refers to a value measured according to JIS Z8803:2011 using a rotational viscometer (for example, available from Toki Sangyo Co., Ltd, product name: TVB-10, rotor No. 3) under conditions of a rotational speed of 20 rpm.

The expression “a polysiloxane compound having at least one hydroxy group not directly bound to a silicon atom at an end, and having no vinyl group” refers to a compound having at least one hydroxy group at one of the ends of the main chain constituting the polysiloxane compound, which is not directly bound to a silicon atom of the polysiloxane compound, and having no vinyl group not only at ends, but also in the main chain constituting the polysiloxane compound.

The term “weight-average molecular weight (Mw)” refers to the weight-average molecular weight in terms of polystyrene as measured by gel permeation chromatography (GPC).

The term “thermal conductivity of a cured product of the thermally conductive composition” refers to a value measured according to ISO22007-2 using a hot-disk method and a thermophysical property measuring device (available from Kyoto Electronics Manufacturing Co., Ltd., product name TPS 2500 S).

Regarding preferable numerical ranges (for example, the range of content, etc.), lower limits and upper limits described in stages can be each independently combined. For example, based on a description, “preferably 10 to 90, more preferably 30 to 60”, “preferable lower limit (10)” and “more preferable upper limit (60)” can also be combined to be “10 to 60”.

The term “viscosity immediately after production of the thermally conductive composition” refers to viscosity for up to 5 minutes after production of the thermally conductive composition.

### [Thermally Conductive Composition]

The thermally conductive composition of this embodiment is a thermally conductive composition containing a resin composition and a thermally conductive filler, wherein the resin composition contains a liquid silicone resin having a viscosity ranging from 20 mPa·s to 200,000,000 mPa·s at 25° C. as measured according to JIS Z8803:2011 and a polysiloxane compound having at least one hydroxy group not directly bound to a silicon atom at an end, and having no vinyl group, and the mass ratio of the liquid silicone resin to the polysiloxane compound [the liquid silicone resin/the polysiloxane compound] is 50/50 or more and less than 90/10. Moreover, the content of the thermally conductive filler ranges from 300 parts by mass to 5,000 parts by mass with respect to 100 parts by mass of the resin composition, and a cured product of the thermally conductive composition has a thermal conductivity of 1.0 W/mk or more as measured according to ISO22007-2.

The thermally conductive composition of this embodiment contains a resin composition containing a predetermined liquid silicone resin and a predetermined polysiloxane compound, so that the viscosity immediately after production is low and a cured product having appropriate hardness can be obtained.

### <Resin Composition>

The resin composition of this embodiment contains a liquid silicone resin having a viscosity ranging from 20 mPa·s to 200,000,000 mPa·s at 25° C. as measured according to JIS Z8803:2011, and a polysiloxane compound having at least one hydroxy group not directly bound to a silicon atom at an end, and having no vinyl group. Moreover, the mass ratio of the liquid silicone resin to the polysiloxane compound in the resin composition [the liquid silicone resin/the polysiloxane compound] is 50/50 or more and less than 90/10.

The content of the resin composition in the thermally conductive composition of this embodiment with respect to the total amount of the thermally conductive composition is preferably 1.0 mass % or more and 30.0 mass % or less, more preferably 2.0 mass % or more and 20.0 mass % or less, and further preferably 3 mass % or more and 15 mass % or less. If the content of the liquid silicone resin is 1.0 mass % or more, thermally conductive filler can be mixed with a liquid resin by kneading, and if the content of the liquid silicone resin is 30.0 mass % or less, high heat conduction performance can be imparted.

### (Liquid Silicone Resin)

The liquid silicone resin to be used in this embodiment has a viscosity ranging from 20 mPa·s to 200,000,000 mPa·s at 25° C. as measured according to JIS Z8803:2011. Here, the term “liquid silicone resin” refers to a silicone resin that is liquid or has flowability at room temperature (25° C.).

The liquid silicone resin having a viscosity of 20 mPa·s or more is excellent in thermal stability, and the same having a viscosity of 200,000,000 mPa·s or less can be filled to a high degree with a thermally conductive filler. From such a viewpoint, the viscosity ranges from preferably 25 mPa·s to 20,000,000 mPa·s, more preferably 30 mPa·s to 10,000,000 mPa·s, and further preferably 35 mPa·s to 5,000,000 mPa·s.

The liquid silicone resin is not particularly limited, as long as the viscosity at 25° C. is within the above range, and an example thereof is a resin having an organopolysiloxane structure as the main chain.

Examples of a resin having an organopolysiloxane structure as the main chain include a curable-type silicone resin and a non-curable-type silicone resin. Examples of the curable-type silicone resin include an addition reaction curable-type silicone resin, a condensation reaction curable-type silicone resin, and an organic peroxide curable-type silicone resin. Regarding a curable-type silicone resin, the one filled with a thermally conductive filler can be used as a heat dissipation sheet and a heat dissipation gel. The term “non-curable-type silicone resin” refers to an organopolysiloxane in which the base polymer has no curable functional group such as an alkenyl group, and is also referred to as a non-reactive silicone oil. The most general example thereof is a dimethyl silicone oil, and the one filled with a thermally conductive filler can be used as heat dissipation grease and heat dissipation putty. The silicone oil may also be an alkyl-modified silicone oil.

Note that herein, the term “silicone oil” refers to the one having a relatively low polymerization degree (for example, a polymerization degree ranging from 50 to 10,000) and is oily at room temperature (25° C.) among silicone resins.

When the liquid silicone resin is a curable-type silicone resin, the curable-type silicone resin may also have a functional group other than curable functional groups.

In this embodiment, the liquid silicone resin is preferably a curable-type silicone resin in view of lowering the viscosity immediately after production, and obtaining a cured product having more appropriate hardness. Specifically, the curable-type silicone resin is preferably at least one selected from the group consisting of an addition reaction curable-type silicone resin, a condensation reaction curable-type silicone resin, and an organic peroxide curable-type silicone resin.

The addition reaction curable-type silicone resin (also simply referred to as an addition-type silicone resin.) is a resin that is cured as a result of addition reaction of an alkenyl group contained as a reactive functional group.

An example of the addition-type silicone resin is an organopolysiloxane provided with an alkenyl group such as a vinyl group, an allyl group, a propenyl group, a butenyl group, a pentenyl group, a hexenyl group, a heptenyl group, and an octenyl group at a molecular end and/or side chain.

The condensation reaction curable-type silicone resin (also simply referred to as a condensation-type silicone resin.) is a resin that is cured through hydrolysis followed by condensation reaction, and has a hydroxy group directly bound to a silicon atom.

Examples of the condensation-type silicone resin include resins methyltrichlorosilane, methyltrimethoxysilane, methyltriethoxysilane, tetrachlorosilane, tetramethoxysilane, and tetraethoxysilane, obtained by hydrolysis and condensation reaction.

The organic peroxide curable-type silicone resin (also simply referred to as a peroxide-type silicone resin.) is a resin resulting from a process such that a radical generated from a cross-linking agent, organic peroxide, withdraws a hydrogen of a Si—CH₃ group of a peroxide-type silicone resin, and then the thus generated Si—CH₂ radicals bind to each other to proceed a crosslinking reaction.

Examples of the peroxide-type silicone resin include an organopolysiloxane and the like having a dimethylsiloxane or the like as a main constitutional unit.

In this embodiment, the liquid silicone resin is not particularly limited, but a condensation-type silicone resin is preferably contained as the liquid silicone resin in view of improving the ease of controlling the reaction rate and storability.

When at least one selected from an addition-type silicone resin and a peroxide-type silicone resin is contained as the liquid silicone resin, the mass ratio of the liquid silicone resin and the polysiloxane compound in the resin composition of this embodiment [the liquid silicone resin/the polysiloxane compound] is, in view of obtaining a cured product having more appropriate hardness, preferably 88/12 or less, more preferably 86/14 or less, and further preferably 84/16 or less, and is, in view of lowering the viscosity immediately after production, preferably 55/45 or more, more preferably 60/40 or more, and further preferably 65/35 or more. Specifically, when at least one selected from an addition-type silicone resin and a peroxide-type silicone resin is contained as the liquid silicone resin, the mass ratio of the liquid silicone resin and the polysiloxane compound in the resin composition is preferably 55/45 or more and 88/12 or less, more preferably 60/40 or more and 86/14 or less, and further preferably 65/35 or more and 84/16 or less.

When a condensation-type silicone resin is contained as the liquid silicone resin, the mass ratio of the liquid silicone resin and the polysiloxane compound in the resin composition of this embodiment [the liquid silicone resin/the polysiloxane compound] is, in view of obtaining a cured product having more appropriate hardness, preferably 85/15 or less and more preferably 80/20 or less, and is, in view of lowering the viscosity immediately after production, preferably 55/45 or more, and more preferably 60/40 or more. Specifically, when a condensation-type silicone resin is contained as the liquid silicone resin, the mass ratio of the liquid silicone resin and the polysiloxane compound in the resin composition is preferably 55/45 or more and 88/15 or less, and more preferably 60/40 or more and 80/20 or less.

One liquid silicone resin may be used, and two or more thereof may be mixed and then used.

### (Polysiloxane Compound)

The polysiloxane compound of this embodiment has at least one hydroxy group not directly bound to a silicon atom at an end, and has no vinyl group. The polysiloxane compound is not particularly limited, as long as it has at least one hydroxy group not directly bound to a silicon atom at an end, and has no vinyl group. In view of lowering the viscosity immediately after production, and obtaining a cured product having more appropriate hardness, the polysiloxane compound has preferably at least two hydroxy groups not directly bound to a silicon atom, at one of the ends of the main chain constituting the polysiloxane compound. Moreover, from the same viewpoint, the polysiloxane compound preferably has no hydroxy group not directly bound to a silicon atom, at the other end that is different from the end at which at least one hydroxy group not directly bound to a silicon atom is located. Specifically, the polysiloxane compound preferably has at least one hydroxy group at one of the ends of the main chain constituting the polysiloxane compound, which is not directly bound to a silicon atom, and has no hydroxy group at the other end, which is not directly bound to a silicon atom. The polysiloxane compound more preferably has at least two hydroxy groups that are not directly bound to a silicon atom and located at one of the ends of the main chain, and has no hydroxy group that is not directly bound to a silicon atom and located at the other end.

The polysiloxane compound has a weight-average molecular weight (Mw) of preferably 1,000 or more, more preferably 5,000 or more, and further preferably 10,000 or more, in view of obtaining a cured product having appropriate hardness, and is preferably 20,000 or less, more preferably 18,000 or less, and further preferably 17,000 or less, in view of lowering the viscosity immediately after production, and in view of filling to a high degree with a thermally conductive filler. Specifically, the polysiloxane compound has a weight-average molecular weight (Mw) of preferably 1,000 or more and 20,000 or less, more preferably 5,000 or more and 18,000 or less, and further preferably 10,000 or more and 17,000 or less.

In an aspect of this embodiment, the polysiloxane compound is preferably a compound represented by general formula (1) below.

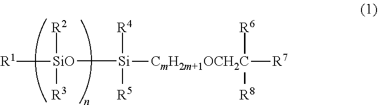

In formula (1), R¹ is an alkyl group having 1 to 18 carbon atoms, or a phenyl group, R² to R⁵ are each independently an alkyl group having 1 to 18 carbon atoms, or a phenyl group, R⁶ and R⁸ are each independently a hydrogen atom, hydroxymethyl group, or a hydroxyethyl group, R⁷ is an alkyl group having 1 to 3 carbon atoms, a hydroxy group, or a phenyl group, n is 5 to 250, and m is an integer of 1 to 20. When there are a plurality of R² above and R³ above, the plurality of R² and R³ are the same or different.

R¹ is preferably an alkyl group having 1 to 18 carbon atoms, more preferably an alkyl group having 1 to 10 carbon atoms, further preferably an alkyl group having 1 to 5 carbon atoms, and even more preferably a butyl group, in view of lowering the viscosity immediately after production and obtaining a cured product having more appropriate hardness.

R² to R⁵ are each independently preferably an alkyl group having 1 to 18 carbon atoms, more preferably an alkyl group having 1 to 10 carbon atoms, further preferably an alkyl group having 1 to 5 carbon atoms, and even more preferably a methyl group, in view of lowering the viscosity immediately after production and obtaining a cured product having more appropriate hardness.

R⁶ and R⁸ are each independently preferably a hydroxymethyl group, or a hydroxyethyl group, and more preferably a hydroxymethyl group, in view of lowering the viscosity immediately after production and obtaining a cured product having more appropriate hardness.

R⁷ is preferably an alkyl group having 1 to 3 carbon atoms, and more preferably an ethyl group, in view of lowering the viscosity immediately after production and obtaining a cured product having more appropriate hardness.

When at least one selected from an addition-type silicone resin and a condensation-type silicone resin is contained as the liquid silicone resin, n is preferably 5 to 80, and more preferably 8 to 70 in view of lowering the viscosity immediately after production and obtaining a cured product having more appropriate hardness. When a peroxide-type silicone resin is contained as the liquid silicone resin, n is preferably 50 to 250 and more preferably 60 to 230 in view of lowering the viscosity immediately after production and obtaining a cured product having more appropriate hardness.

When at least one selected from an addition-type silicone resin and a condensation-type silicone resin is contained as the liquid silicone resin, m is preferably 1 to 20, and more preferably 1 to 10 in view of lowering the viscosity immediately after production and obtaining a cured product having more appropriate hardness.

### <Thermally Conductive Filler>

The content of the thermally conductive filler in the thermally conductive composition of this embodiment ranges from 300 parts by mass to 5,000 parts by mass with respect to 100 parts by mass of the resin composition. In view of obtaining a thermally conductive composition having higher thermal conductivity, the content of the thermally conductive filler in the thermally conductive composition is preferably 500 parts by mass or more, more preferably 600 parts by mass or more, and further preferably 700 parts by mass or more with respect to 100 parts by mass of the resin composition. In view of uniformly kneading and mixing the thermally conductive filler with the liquid silicone resin, the content of the thermally conductive filler is preferably 4,000 parts by mass or less, more preferably 3,000 parts by mass or less, and further preferably 2,000 parts by mass or less. Specifically, the content of the thermally conductive filler in the thermally conductive composition is preferably 500 parts by mass or more and 4,000 parts by mass or less, more preferably 600 parts by mass or more and 3,000 parts by mass or less, and further preferably 700 parts by mass or more and 2,000 parts by mass or less with respect to 100 parts by mass of the resin composition.

The thermally conductive filler to be used in this embodiment has a function of transferring heat generated by electronic devices etc., to the outside of the system and examples thereof include metal, metal nitride, metal oxide, metal carbide, and metal hydroxide. The thermally conductive filler may be used singly or in combination of two or more types thereof.

The thermally conductive filler is preferably metal nitride or metal oxide in view of high thermal conductivity and insulation property, and metal nitride and metal oxide may also be used in combination.

Examples of metal nitride include boron nitride, aluminum nitride, and silicon nitride. Of these, aluminum nitride is preferable in view of high thermal conductivity and high ability to fill a resin.

Examples of metal oxide include such as zinc oxide, alumina, magnesium oxide, silicon dioxide, and iron oxide. Of these, alumina is preferable in view of high thermal conductivity, a lineup of various granularities, and a high degree of freedom for combination with metal nitride.

The particle size at a cumulative volume of 50% (hereinafter, denoted as D50) in the particle size distribution of the thermally conductive filler measured by the laser diffraction light-scattering method is preferably 0.2 μm or more and 200 μm or less, more preferably 0.5 μm or more and 100 μm or less, and further preferably 1.0 μm or more and 50 μm or less in view of adjustment of the thickness of a thermal conductive material, and handleability upon kneading a liquid resin with the thermally conductive filler.

D50 of the thermally conductive filler can be measured by a grading analyzer, and specifically measured according to a method described in Examples.

The thermally conductive filler has preferably a hydroxy group. When the thermally conductive filler has a hydroxy group, the hydroxy group interacts with a hydroxy group(s) of the polysiloxane compound having at least one hydroxy group not directly bound to a silicon atom at an end, because of intermolecular force, hydrogen bonding, and the like, the interaction between thermally conductive fillers via hydroxy groups is lowered in association therewith, the viscosity of the resin composition is even lowered, and thus, a cured product having appropriate hardness will be more easily obtained.

### (Aluminum Nitride)

Known products such as commercially available aluminum nitride products can be used. Aluminum nitride may be obtained by any production method such as a direct nitriding method that involves directly reacting metal aluminum powder with nitrogen or ammonia, and a reduction nitriding method that involves performing carbothermic reduction of alumina simultaneously with a nitriding reaction that is performed by heating in a nitrogen or ammonia atmosphere.

The shape of aluminum nitride is not particularly limited, and examples thereof include amorphous (crushed), spherical, ellipsoidal, and platy (flaky) shapes.

Further, the particle size at a cumulative volume of 50% (D50) in the particle size distribution of aluminum nitride as measured by the laser diffraction light-scattering method is preferably 0.2 μm or more and 200 μm or less, more preferably 10 μm or more and 100 μm or less, and further preferably 10 μm or more and 50 μm or less.

Aluminum nitride preferably has a silicon-containing oxide film on its surface in view of improving the moisture resistance. Specifically, surface-treated aluminum nitride is preferable. The silicon-containing oxide film may partially or entirely cover the surface of aluminum nitride, and preferably covers the entire surface of aluminum nitride.

Since aluminum nitride has excellent thermal conductivity, aluminum nitride having a silicon-containing oxide film on its surface (hereinafter also referred to as silicon-containing oxide-coated aluminum nitride) also has excellent thermal conductivity.

Examples of the “silicon-containing oxide” of the silicon-containing oxide film and silicon-containing oxide-coated aluminum nitride particles include silica and an oxide containing silicon and aluminum.

Regarding the silicon-containing oxide-coated aluminum nitride, the coverage with the silicon-containing oxide film covering the surface of the aluminum nitride is preferably 70% or more and 100% or less, more preferably 70% or more and 95% or less, further preferably 72% or more and 90% or less, and particularly preferably 74% or more and 85% or less as determined by LEIS analysis. When the coverage is 70% or more and 100% or less, the resulting moisture resistance is more excellent. Further, when the coverage exceeds 95%, the thermal conductivity may decrease.

The coverage (%) of a silicon-containing oxide film (SiO2) covering the surface of aluminum nitride as determined by LEIS (Low Energy Ion Scattering) analysis is found by the following formula.

(S_{Al}(AlN)—S_{Al}(AlN+SiO₂))/S_{Al(AlN)×}100

In the above formula, S_{Al}(AlN) is the area of the Al peak of aluminum nitride, and S_{Al}(AlN+SiO₂) is the area of the Al peak of the silicon-containing oxide-coated aluminum nitride. The area of the Al peak can be determined by low energy ion scattering (LEIS) analysis, which is a measurement method using an ion source and a rare gas as probes. LEIS is an analysis technique in which rare gas of several keV is used as incident ions and is an evaluation technique that enables compositional analysis of the outermost surface (reference literature: The TRC News 201610-04 (October 2016)).

An example of the method for forming a silicon-containing oxide film on the surface of aluminum nitride is a method that involves a first step of covering the surface of aluminum nitride with a siloxane compound having a structure represented by formula (2) below, and a second step of heating the aluminum nitride covered with the siloxane compound at a temperature of 300° C. or higher and 800° C. or lower.

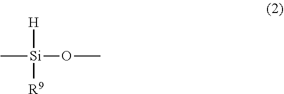

In formula (2), R⁹ is an alkyl group having 4 or less carbon atoms.

The structure represented by formula (2) is a hydrogen siloxane structural unit having a Si—H bond. In formula (2), R⁹ is an alkyl group having 4 or less carbon atoms, that is, a methyl group, an ethyl group, a propyl group, or a butyl group, and is preferably a methyl group, an ethyl group, an isopropyl group, or a t-butyl group, and more preferably a methyl group.

The siloxane compound is preferably an oligomer or a polymer containing the structure represented by formula (2) as a repeating unit. Further, the siloxane compound may be linear, branched, or cyclic. The weight-average molecular weight of the siloxane compound ranges from preferably 100 to 2,000, more preferably 150 to 1,000, and further preferably 180 to 500, in view of the ease of forming a silicon-containing oxide film with uniform thickness. The weight-average molecular weight is a value in terms of polystyrene as measured by gel permeation chromatography (GPC).

The siloxane compounds that are suitably used are a compound represented by formula (3) below and/or a compound represented by formula (4) below.

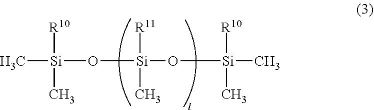

In formula (3), R¹⁰ and R¹¹ are each independently a hydrogen atom or a methyl group, at least one of R¹⁰ and R¹¹ is a hydrogen atom, 1 is an integer of 0 to 10, preferably 1 to 5, and more preferably 1.

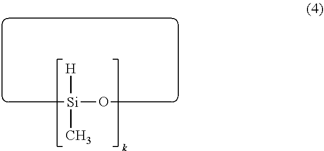

In formula (4), k is an integer of 3 to 6, preferably 3 to 5, and more preferably 4.

The siloxane compound is particularly preferably a cyclic hydrogen siloxane oligomer with n being 4 in formula (4) in view of the ease of forming a good silicon-containing oxide film.

In the first step, the surface of aluminum nitride is covered with a siloxane compound having the structure represented by formula (2) above.

In the first step, the method thereof is not particularly limited, as long as the surface of aluminum nitride can be covered with a siloxane compound having the structure represented by formula (2) above. An example of the method of the first step is a dry mixing method that involves adding the siloxane compound by spraying or the like under stirring aluminum nitride as a raw material using a general powder mixing device, followed by dry mixing for coating.

Examples of the powder mixing device include ribbon blenders having mixing impellers such as a Henschel mixer (available from NIPPON COKE & ENGINEERING CO., LTD.), a vessel rotating V-blender, and a double cone blender, screw blenders, closed rotary kilns, and stirring with a stirrer in a closed container using a magnetic coupling. The temperature condition is not particularly limited, but the temperature ranges from preferably 10° C. or higher and 200° C. or lower, more preferably 20° C. or higher and 150° C. or lower, and further preferably 40° C. or higher and 100° C. or lower.

It is also possible to use a vapor-phase adsorption method that involves depositing or vapor-depositing the vapor of the siloxane compound alone or a mixed gas with an inert gas such as a nitrogen gas on the surface of aluminum nitride that is left to stand. The temperature condition is not particularly limited, and the temperature ranges from preferably 10° C. or higher and 200° C. or lower, more preferably 20° C. or higher and 150° C. or lower, and further preferably 40° C. or higher and 100° C. or lower. Further, if necessary, the inside of the system can be pressurized or decompressed. As a device that can be used in this case, a closed device that can easily replace the gas inside the system is preferable, and for example, a glass container, a desiccator, a CVD device or the like can be used.

The amount of the siloxane compound to be used in the first step is not particularly limited. In the aluminum nitride covered with the siloxane compound to be obtained in the first step, the amount of the siloxane compound applied for coating ranges from preferably 0.1 mg or more and 1.0 mg or less, more preferably 0.2 mg or more and 0.8 mg or less, and ranges from further preferably 0.3 mg or more and 0.6 mg or less, per 1 m² of the surface area calculated from the specific surface area (m²/g) of the aluminum nitride as determined by the BET method. When the amount of the siloxane compound applied for coating is within such a range, aluminum nitride having a silicon-containing oxide film with uniform thickness can be obtained.

The amount of the siloxane compound applied for coating per 1 m² of the surface area calculated from the specific surface area (m²/g) of the aluminum nitride as determined by the BET method can be found by dividing a difference between the mass of the aluminum nitride before and that of the same after coating with the siloxane compound by the surface area (m²) calculated from the specific surface area (m²/g) of the aluminum nitride as determined by the BET method.

The specific surface area determined by the BET method can be measured from the single-point BET nitrogen adsorption based on the gas flow method. As an evaluation device, Macsorb HM model-1210, available from Mountech Co., Ltd., can be used.

In the second step, the aluminum nitride covered with the siloxane compound obtained in the first step is heated at a temperature of 300° C. or higher and 850° C. or lower. This makes it possible to form a silicon-containing oxide film on the surface of aluminum nitride. The heating temperature is more preferably 400° C. or higher, and further preferably 500° C. or higher.

The heating time ranges from preferably 30 minutes or more and 6 hours or less, more preferably 45 minutes or more and 4 hours or less, further preferably 1 hour or more and 2 hours or less, in view of ensuring a sufficient reaction time and efficiently forming a good silicon-containing oxide film.

The atmosphere during the heat treatment is preferably an atmosphere containing oxygen gas, for example, the atmosphere (in-air).

The silicon-containing oxide-coated aluminum nitride particles after the heat treatment in the second step may be in a partially fused state, but in such a case, it is de-agglomerated, for example, using a general grinder such as a roller mill, a hammer mill, a jet mill, and a ball mill, so that a silicon-containing oxide-coated aluminum nitride without sticking and agglomeration can be obtained.

Further, after the completion of the second step, the first step and the second step may be further sequentially performed. That is, the process of sequentially performing the first step and the second step may be repeated.

### (Alumina)

Alumina has thermal conductivity and is excellent in moisture resistance. As alumina, α-alumina (α-Al₂O₃) is preferable. Other than α-alumina, γ-alumina, θ-alumina, δ-alumina and the like may also be included.

Known products such as commercially available alumina products can be used. Known alumina such as commercially available products having a wide variety of types in terms of such as particle size and shape and being the most suitable can be selected, and is also inexpensive.

Alumina may be produced by any method, such as a thermal decomposition method for ammonium alum, a thermal decomposition method for ammonium aluminum carbonate, an underwater spark discharge method for aluminum, a gas-phase oxidation method, and a hydrolysis method for aluminum alkoxide.

The shape of alumina is not particularly limited, and examples thereof include amorphous (crushed), spherical, rounded, and polyhedral shapes.

Further, the particle size at a cumulative volume of 50% (D50), in the particle size distribution of alumina as measured by the laser diffraction light-scattering method is not particularly limited and is preferably 0.1 μm or more and 50 μm or less.

For example, in the case of alumina, surface treatment is preferably performed for alumina in view of obtaining a cured product having more appropriate hardness. Example of a surface treatment method is a method that involves treating the surface of alumina using a silane coupling agent. Examples of the silane coupling agent include butyltrimethoxysilane, hexyltrimethoxysilane, octyltrimethoxysilane, decyltrimethoxysilane, and hexadecyltrimethoxysilane. Of these, octyltrimethoxysilane, decyltrimethoxysilane, and hexadecyltrimethoxysilane are preferable and decyltrimethoxysilane is more preferable in view of obtaining a cured product having more appropriate hardness.

The silane coupling agent may be used singly or in combination of two or more types thereof.

The amount of a silane coupling agent to be used is preferably 0.01 parts by mass or more and 10 parts by mass or less, more preferably 0.02 parts by mass or more and 5 parts by mass or less with respect to 100 parts by mass of alumina. Through the use of the amount of a silane coupling agent within the above range, the surface of alumina can be sufficiently treated.

A typical method for treating alumina with a silane coupling agent is a dry mixing method that involves adding the silane coupling agent by spraying or the like under stirring alumina as a raw material using a general powder mixing device, followed by dry mixing.

Examples of the powder mixing device include a Henschel mixer (available from NIPPON COKE & ENGINEERING CO., LTD.) and a SPARTAN granulator (available from DALTON CORPORATION).

When alumina is treated with a silane coupling agent as described above, heat treatment is preferably performed at a temperature ranging from 100° C. to 140° C. for 1 to 5 hours after mixing, and more preferably performed at a temperature ranging from 110° C. to 130° C. for 2 to 4 hours after mixing.

The total content of aluminum nitride and alumina contained in the thermally conductive filler is preferably 90 mass % or more, more preferably 95 mass % or more, and particularly preferably 100 mass % in view of increasing the thermal conductivity.

The thermally conductive filler that may be used herein is composed of those having different particle sizes. For example, when the filler is composed of alumina having a small particle size (e.g., D50 is 0.1 μm or more and 50 μm or less) and aluminum nitride having a particle size larger than that of alumina (e.g., D50 is 10 μm or more and 100 μm or less), the amount of thermally conductive powder used for filling (mass %) in the thermally conductive composition can be increased, and thus the thermal conductivity of the thermally conductive composition can be more increased.

The content of the thermally conductive filler is preferably 70.0 mass % or more and 99.0 mass % or less, more preferably 75.0 mass % or more and 99.0 mass % or less, and further preferably 80 mass % or more and 98 mass % or less with respect to the total amount of the thermally conductive composition of this embodiment. When the content of the thermally conductive powder is 70.0 mass % or more, the thermal conductivity of the thermally conductive composition can be increased, and when the content of the same is 99.0 mass % or less, the thermally conductive filler can be kneaded and mixed with a liquid silicone resin.

In addition to the aforementioned components, the thermally conductive composition of this embodiment can contain additives such as a cross-linking agent, a reaction accelerator, a retarder, a heat resistant agent, a flame retardant, a pigment, a flexibility-imparting agent, an inorganic ion scavenger, a pigment, a dye, and a diluent as required, as long as the effects of the present invention are not inhibited.

The content of an additive(s) in the thermally conductive composition is preferably 0 part by mass or more and 200 parts by mass or less with respect to 100 parts by mass of the resin composition of this embodiment.

The content of an additive(s) in the thermally conductive composition is preferably 0 mass % or more and 20 mass % or less with respect to the total amount of the thermally conductive composition of this embodiment.

### <Cross-Linking Agent>

The thermally conductive composition of this embodiment may contain a cross-linking agent in view of obtaining a cured product having more appropriate hardness.

Examples of the cross-linking agent include polydimethylhydrosiloxane having a silicon-hydrogen bond, when the liquid silicone resin contains an addition-type silicone resin, and include trialkoxysilane and dialkoxysilane represented by a silane coupling agent having two or more alkoxy groups, when the liquid silicone resin contains a condensation-type silicone resin.

These cross-linking agents may be used singly, or in combinations of two or more thereof.

The thermally conductive composition of this embodiment contains preferably a cross-linking agent, when the liquid silicone resin contains a condensation-type silicone resin.

When the liquid silicone resin contains an addition-type silicone resin, the addition-type silicone resin represented by formula (5) below and the cross-linking agent represented by formula (6) below are preferably used in combination.

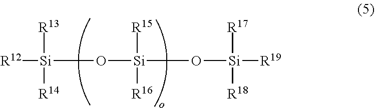

In formula (5), R¹² and R¹⁹ are each independently an alkenyl group, preferably a vinyl group or an allyl group.

R¹³ to R¹⁸ are each independently an alkyl group having 1 to 8 carbon atoms, or a phenyl group, and preferably a methyl group.

o is an integer of 10 to 1,000.

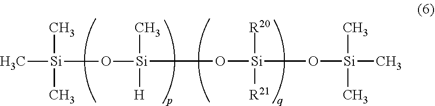

In formula (6), R²⁰ and R²¹ are each independently an alkyl group having 1 to 8 carbon atoms or a phenyl group, and more preferably a methyl group.

p is 0 to 1,000, q is 0 to 100, and p/q is preferably 0 to 100.

When the liquid silicone resin contains a condensation-type silicone resin, the condensation-type silicone resin represented by formula (7) below, and as a cross-linking agent, at least one selected from the group consisting of tetraalkoxysilane, trialkoxysilane, dialkoxysilane, both-end trialkoxyalkene, alkyltriacetoxysilane, alkenyl triacetoxysilane, both-end alkoxy group-terminated silicone, and one-end alkoxy group-terminated silicone, as well as partial hydrolysates of the above compounds, and two or more types of hydrolysate differing from the above compounds are preferably used in combination.

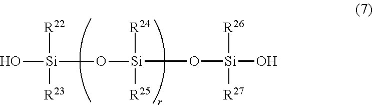

In formula (7), R²² to R²⁷ are each independently an alkyl group having 1 to 8 carbon atoms, or a phenyl group, and preferably a methyl group or a phenyl group.

r is 10 to 500.

When the liquid silicone resin contains a peroxide-type silicone resin, the liquid silicone resin represented by formula (8) below, and an organic peroxide as a cross-linking agent are preferably used in combination.

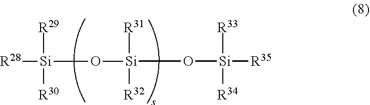

In formula (8), R²⁸ and R³⁵ are each independently an alkyl group having 1 to 8 carbon atoms, an alkenyl group, or a hydroxy group, preferably an alkenyl group, and more preferably a vinyl group.

R²⁹ to R³⁴ are methyl groups or phenyl groups and preferably methyl groups.

s is 600 to 3000.

Examples of the organic peroxide include benzoyl peroxide, 2,4-dichlorobenzoyl peroxide, p-methylbenzoyl peroxide, o-methylbenzoyl peroxide, 2,4-dicumyl peroxide, 2,5-dimethyl-bis(2,5-t-butylperoxy)hexane, di-t-butyl peroxide, t-butyl perbenzoate, and 1,1-bis(t-butylperoxy carboxy)hexane.

Of these, benzoyl peroxide, 2,4-dichlorobenzoyl peroxide, p-methylbenzoyl peroxide, and o-methylbenzoyl peroxide are preferable in view of the possibility of extruding.

The content of a cross-linking agent in the thermally conductive composition is preferably 0.001 mass % or more and 10 mass % or less, more preferably 0.01 mass % or more and 5 mass % or less, further preferably 0.1 mass % or more and 1 mass % or less with respect to the total amount of the thermally conductive composition of this embodiment.

### <Reaction Accelerator>

The thermally conductive composition of this embodiment may contain a reaction accelerator.

When the liquid silicone resin contains an addition-type silicone resin, examples of the reaction accelerator include a platinum catalyst. Examples of the platinum catalyst include platinic chloride, alcohol-modified platinum, and siloxane-modified platinum.

When the liquid silicone resin contains a condensation-type silicone resin, examples of the reaction accelerator include an organometallic compound and a tertiary amine compound. Examples of the organometallic compound include an organic tin compound, an organic titanium compound, an organic aluminum compound, an organic zirconium compound, an organic bismuth compound, an organic tungsten compound, an organic molybdenum compound, an organic cobalt acid compound, an organic zinc compound, an organic potassium compound, and an organic iron compound.

When the liquid silicone resin contains a peroxide-type silicone resin, examples of the reaction accelerator include an amine compound and an organic cobalt acid.

The reaction accelerators may be used singly, or in combinations of two or more thereof.

Regarding the reaction accelerator, a compound and an amount thereof appropriate for the reaction mechanism are preferably selected.

The content of the reaction accelerator in the thermally conductive composition is preferably 0 part by mass or more and 1 part by mass or less with respect to 100 parts by mass of the resin composition of this embodiment.

The content of the reaction accelerator in the thermally conductive composition is preferably 0 mass % or more and 1 mass % or less with respect to the total amount of the thermally conductive composition of this embodiment.

### <Retarder>

The thermally conductive composition of this embodiment may contain a retarder.

When the liquid silicone resin contains an addition-type silicone resin, examples of the retarder include acetylene alcohol. Specific examples of the acetylene alcohol include 2-methyl-3-butyn-2-ol and ethynylcyclohexanol.

When the liquid silicone resin contains a condensation-type silicone resin, examples of the retarder include a siloxane having a low molecular weight and hydroxy groups at both ends.

When the liquid silicone resin contains a peroxide-type silicone resin, examples of the retarder include hydroquinones. Specific examples of hydroquinones include 4-tert-butylphenol.

The retarders may be used singly, or in combinations of two or more thereof.

Regarding the retarder, a compound and an amount thereof appropriate for the reaction mechanism are preferably selected.

The content of the retarder in the thermally conductive composition is preferably 0 part by mass or more and 5 parts by mass or less with respect to 100 parts by mass of the resin composition of this embodiment.

The content of the retarder in the thermally conductive composition is preferably 0 mass % or more and 1 mass % or less with respect to the total amount of the thermally conductive composition of this embodiment.

The viscosity immediately after production of the thermally conductive composition of this embodiment is preferably 50 Pa·s or more and 2,000 Pa·s or less, more preferably 100 Pa·s or more and 1,500 Pa·s or less, and further preferably 150 Pa·s or more and 1,000 Pa·s or less.

The viscosity can be measured using a flow viscometer by a method according to JIS K7210:2014, specifically, by the method described in Examples.

The thermally conductive composition of this embodiment has a consistency of preferably 250 or more and 400 or less, and more preferably 260 or more and 350 or less.

Herein, the consistency is an index of the flexibility of the thermally conductive composition, and a higher value thereof means that the thermally conductive composition is softer; that is, exhibiting low viscosity.

The consistency can be measured by a method according to JIS K2220:2013, specifically, by the method described in Examples.

### [Method for Producing Thermally Conductive Composition]

The method for producing the thermally conductive composition is not particularly limited. For example, the thermally conductive composition can be obtained by supplying the liquid silicone resin, the polysiloxane, the thermally conductive filler, and various additives to be added as required simultaneously or in divided portions to a dispersion/dissolution apparatus, and then mixing, dissolving, and kneading, while heating as required. Examples of the dispersion/dissolution apparatus include a mortar machine, a planetary mixer, a rotation/revolution mixer, a kneader, and a roll mill.

### [Cured Product of Thermally Conductive Composition]

The thermal conductivity of a cured product of the thermally conductive composition of this embodiment is 1.0 W/mK or more as measured according to ISO22007-2. In view of removing heat from a heating element, the thermal conductivity is preferably 3 W/mK or more, more preferably 5.0 W/mK or more, and further preferably 6 W/mK or more, and in view of viscosity; that is, coatability and workability, the thermal conductivity is preferably 12 W/mK or less, more preferably 10 W/mK or less, and further preferably 8 W/mK or less. Specifically, the thermal conductivity of a cured product of the thermally conductive composition is preferably 3 W/mK or more and 12 W/mK or less, more preferably 5.0 W/mK or more and 10 W/mK or less, and further preferably 6 W/mK or more and 8 W/mK or less.

When the thermally conductive composition of this embodiment contains an addition-type silicone resin, a cured product of the thermally conductive composition has a C hardness of preferably 20 or more and 75 or less, more preferably 25 or more and 70 or less, and further preferably 30 or more and 65 or less as measured according to the hardness test (type C) of JIS K7312:1996. With the C hardness within the above range, a cured product having appropriate hardness can be obtained.

The C hardness can be specifically measured by the method described in Examples.

In addition, a cured product for measurement of the C hardness can be prepared by the method described in Examples, wherein an addition-type silicone resin is contained.

When the thermally conductive composition of this embodiment contains a condensation-type silicone resin or a peroxide-type silicone resin, a cured product of the thermally conductive composition has an A hardness of preferably 20 or more and 100 or less, more preferably 25 or more and 97 or less, and further preferably 30 or more and 95 or less as measured according to the hardness test (type A) of JIS K7312:1996. With the A hardness within the above range, a cured product having appropriate hardness can be obtained.

The A hardness can be specifically measured by the method described in Examples.

Further, in the case of the thermally conductive composition containing a condensation-type silicone resin, a cured product for measurement of the above A hardness can be prepared by the method described in Examples, wherein the condensation-type silicone resin is contained.

Further, in the case of the thermally conductive composition containing a peroxide-type silicone resin, a cured product for measurement of the A hardness can be prepared by the method described in Examples, wherein the peroxide-type silicone resin is contained.

### [Method for Producing Cured Product of Thermally Conductive Composition]

A cured product of the thermally conductive composition of this embodiment can be obtained by curing the thermally conductive composition at room temperature (25° C.), by heating or by the use of moisture, for example.

When the liquid silicone resin contains an addition-type silicone resin, a cured product can be obtained by reacting at room temperature (25° C.) or by heating, for example. When the thermally conductive composition is cured by heating, the heating is preferably performed under conditions of a temperature of 50° C. or higher and 150° C. or lower and 5 minutes or more and 2 hours or less, and more preferably performed under conditions of a temperature of 60° C. or higher and 120° C. or lower and 10 minutes or more and 1 hour or less.

When the liquid silicone resin contains a condensation-type silicone resin, for example, a cured product can be obtained by reacting at room temperature (25° C.), by heating or by the use of moisture. When the thermally conductive composition is cured by heating, the heating is preferably performed under conditions of a temperature of 50° C. or higher and 150° C. or lower and 5 minutes or more and 2 hours or less, and more preferably performed under conditions of a temperature of 60° C. or higher and 120° C. or lower and 10 minutes or more and 1 hour or less.

When the liquid silicone resin contains a peroxide-type silicone resin, for example, a cured product can be obtained by reacting at room temperature (25° C.) or by heating. When the thermally conductive composition is cured by heating, primary vulcanization is performed under conditions of a temperature of 50° C. or higher and 150° C. or lower, preferably a temperature of 60° C. or higher and 120° C. or lower, and 5 minutes or more and 2 hours or less, preferably 10 minutes or more and 1 hour or less, subsequently, secondary vulcanization is preferably performed under conditions of a temperature of 100° C. or higher and 250° C. or lower, preferably 150° C. or higher and 230° C. or lower, and 1 hour or more and 10 hours or less, preferably 2 hours or more and 6 hours or less. In addition, when primary vulcanization is performed, it is preferably performed under conditions of a pressure ranging from 0.1 MPa to 1.0 MPa.

### [Method for Using Thermally Conductive Composition]

In an aspect of this embodiment, the thermally conductive composition of this embodiment may also be used after mixing of the liquid silicone, the polysiloxane compound, and the thermally conductive filler, followed by filling of a container with the resultant.

In another aspect of this embodiment, the thermally conductive composition of this embodiment may also be used after filling of a container with the liquid silicone, the polysiloxane compound, and the thermally conductive filler, respectively.

The thermally conductive composition of this embodiment exhibits low viscosity immediately after production, and enables to obtain a cured product having appropriate hardness, so that the thermally conductive composition can be suitably used for exothermic electronic devices such as electronic instrument, personal computers, automotive ECUs and batteries, and is particularly suitably used for semiconductor packages.

### EXAMPLES

Next, the present invention is specifically described below by way of Examples. However, the present invention is not limited at all by Examples below.

### [Raw-Material Compounds]

Details about raw-material compounds used in Production Examples A-1 to A-4, Production Examples B-1 and B-2, Examples 1 to 14, as well as comparative Examples 1 to 20 are as described below.

### (Metal Oxide (Thermally Conductive Filler))

Filler A-1(alumina): AES-12, available from SUMITOMO CHEMICAL COMPANY, LIMITED, average particle size: 0.5 μm, specific surface area (BET method): 5.8 m²/g
Filler A-2 (alumina): BAK-5, available from Shanghai Baitu Company, average particle size: 5 μm, specific surface area (BET method): 0.36 m²/g
Filler A-3 (alumina): high-purity alumina AKP-30, available from SUMITOMO CHEMICAL COMPANY, LIMITED, average particle size: 0.3 μm, specific surface area (BET method): 7.0 m²/g
Filler A-4 (alumina): advanced alumina AA-03, available from SUMITOMO CHEMICAL COMPANY, LIMITED, average particle size: 3.0 μm, specific surface area (BET method): 0.5 m²/g
Filler A-5 (alumina): alumina AL45H, available from Showa Denko K.K., average particle size: 3.0 μm, specific surface area (BET method): 1.2 m²/g
Filler A-6 (alumina): rounded alumina AS-05, available from Showa Denko K.K., average particle size: 45 μm, specific surface area (BET method): 0.1 m²/g

### (Alkoxysilane)

Alkoxysilane 1: KBM-3103C (decyltrimethoxysilane), available from Shin-Etsu Chemical Co., Ltd.
Alkoxysilane 2: Dynasylan®9116 (hexadecyltrimethoxysilane), EVONIK JAPAN CO., LTD.

### (Metal Nitride (Thermally Conductive Filler))

Filler B-1 (aluminum nitride): TOYALNITE® TFZ-560X, available from Toyo Aluminium K.K., average particle size: 55 μm, specific surface area (BET method): 0.1 m²/g, pulverized
Filler B-2 (aluminum nitride): TOYALNITE® TFZ-N15P, available from Toyo Aluminium K.K., average particle size: 15 μm, specific surface area (BET method): 0.9 m²/g, pulverized
Filler B-3 (aluminum nitride): FAN-f80-A1, available from Furukawa Denshi Co., Ltd., average particle size: 76 μm, specific surface area (BET method): 0.05 m²/g, granular

### (Siloxane Compound)

Siloxane compound 1 (D4H): 1,3,5,7-tetramethylcyclotetrasiloxane, Tokyo Chemical Industry Co., Ltd.

### (Liquid Silicone Resin)

Addition-type silicone resin 1: DOWSIL™ EG-3100 (vinyl group-containing dimethyl silicone rubber), available from Dow Toray Co., Ltd., viscosity at 25° C.: 320 mPa·s
Condensation-type silicone resin 1: XP1465 (both-end hydroxy group-terminated polysiloxane), available from JNC CORPORATION, weight-average molecular weight: 14,000, viscosity at 25° C.: 230 mPa·s
Peroxide-type silicone resin 1: TSE201, available from Momentive Performance Materials Inc., weight-average molecular weight: 800,000, viscosity at 25° C.: 1,000,000 mPa·s or more and 3,000,000 mPa·s or less

### (Polysiloxane Compound)

Polysiloxane compound 1: the compound represented by formula (9) below (diol-terminated polysiloxane, n in formula (9) below is 5 to 250), weight-average molecular weight: 5,000, viscosity at 25° C.: 80 mPa·s to 160 mPa·s

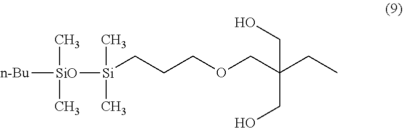

Polysiloxane compound 2: the compound represented by formula (9) above (diol-terminated polysiloxane, n in formula (9) above is 5 to 250), weight-average molecular weight: 15,000, viscosity at 25° C.: 300 mPa·s to 700 mPa·s
Polysiloxane compound 3: KF96-100cs (dimethyl silicone oil having no hydroxy group at ends), Shin-Etsu Chemical Co., Ltd., weight-average molecular weight: 6000, viscosity at 25° C.: 96.5 mPa·s
Polysiloxane compound 4: KF96-500cs (dimethyl silicone oil having no hydroxy group at ends), Shin-Etsu Chemical Co., Ltd., weight-average molecular weight: 17,300, viscosity at 25° C.: 96.5 mPa·s

### (Cross-Linking Agent)

Cross-linking agent 1: TSL8123N (methyltriethoxysilane), available from Momentive Performance Materials Inc.
Cross-linking agent 2: HTS-M (hexyltrimethoxysilane), available from JNC CORPORATION

### (Plasticizer)

Plasticizer 1: TSF458-50 (polydimethylsiloxane), available from Momentive Performance Materials Inc., viscosity 50 mPa·s

### (Catalyst)

Catalyst 1: NEOSTANN S-1 (reactant of alkyl-tin salt and silicate), available from Nitto Kasei Co., Ltd.
Catalyst 2: ORGATIX TC-100 (titanium acetylacetonate), Matsumoto Fine Chemical Co., Ltd.

### (Organic Peroxide)

Vulcanizing agent (curing agent): TC-1 (benzoyl peroxide), available from Momentive Performance Materials Inc.

### (Additive)

KN320 (ferrosoferric oxide, pigment), available from TODA KOGYO CORPORATION

### [Surface Treatment of Thermally Conductive Filler]

Thermally conductive metal oxide fillers (Fillers A-1 to A-4), and thermally conductive metal nitride fillers (fillers B-1 to A-4) were subjected to surface treatment.

The average particle size and the specific surface area of the above metal oxide and the above metal nitride were measured by the following measurement method.

### (1) Average Particle Size

The average particle size was found from the particle size (50% particle size D50) at which cumulative volume was 50% in the particle size distribution measured using a laser diffraction particle size distribution analyzer (available from MicrotracBEL Corp. product name: MT3300EXII).
The term “volume cumulative particle size D50” used herein refers to a particle size, at which the volume cumulative (integrated) value is 50% with respect to a particle size distribution, and is the value found from the particle size (50% particle size D50), at which the cumulative volume was 50% in the particle size distribution measured using the laser diffraction particle size distribution analyzer.

### (2) Specific Surface Area

The specific surface area was measured by single-point BET nitrogen adsorption using a specific surface area measuring device (available from Mountech Co., Ltd., product name: Macsorb MS30).

<Surface Treatment of Metal Oxide>

Surface treatment of metal oxide was performed as described in Production Examples A-1 to A-4 below.

### (Production Example A-1>

100 parts by mass of filler A-1 was multiplied by the specific surface area of filler A-1, the product was divided by the minimum coating area (298 m²/g) of alkoxysilane 1 to give 1.95 parts by mass, 1.95 parts by mass of alkoxysilane 1 was weighed and added as the content of alkoxysilane 1, 5 parts by mass of ethanol was added with respect to 100 parts by mass of filler A-1, water was then added in an amount (0.97 parts by mass) half the value obtained by multiplying 100 parts by mass of the filler A-1 by the specific surface area of filler A-1 and then dividing the product by the minimum coating area of alkoxysilane 1, to obtain a chemical agent, and then the chemical agent was added to filler A-1. The mixture was then stirred and mixed using a rotation/revolution mixer (available from THINKY CORPORATION, product name: ARV-310P) at a rotational speed of 1,000 rpm for 30 seconds, followed by loosening. This operation was repeated four times and then the resultant was air-dried once. Next, the resultant was heated in a hot air circulating oven at a temperature of 120° C. for 2 hours and then cooled, thereby obtaining treated filler A-1, the surface of which had been treated with alkoxysilane 1.

### (Production Example A-2>

Except for using filler A-2 instead of filler A-1, multiplying 100 parts by mass of filler A-2 by the specific surface area of filler A-2, dividing the product by the minimum coating area of alkoxysilane 1 (298 m²/g) to give 0.12 parts by mass, weighing and adding 0.12 parts by mass of alkoxysilane 1 as the content of alkoxysilane 1, adding 5 parts by mass of ethanol with respect to 100 parts by mass of filler A-2, and then adding water in an amount (0.06 parts by mass) half the value obtained by multiplying 100 parts by mass of filler A-2 by the specific surface area of filler 2 and then dividing the product by the minimum coating area of alkoxysilane 1 to obtain a chemical agent, and then adding the chemical agent to filler A-2, treated filler A-2, the surface of which had been treated with alkoxysilane 1, was obtained in the same manner as in Production Example A-1.

### (Production Example A-3>

100 parts by mass of filler A-3 was multiplied by the specific surface area of filler A-3, the product was divided by the minimum coating area of alkoxysilane 2 (226 m²/g) to give 3.10 parts by mass, 3.10 parts by mass of alkoxysilane 2 was weighed and added as the content of alkoxysilane 2, 5 parts by mass of ethanol was added with respect to 100 parts by mass of filler A-3, water was then added in an amount (1.55 parts by mass) half the value obtained by multiplying 100 parts by mass of filler A-3 by the specific surface area of filler A-3, and then dividing the product by the minimum coating area of alkoxysilane 2 to obtain a chemical agent, and then the chemical agent was added to filler A-3. The mixture was stirred and mixed with a rotation/revolution mixer (available from THINKY CORPORATION, product name: ARV-310P) at a rotational speed of 1,000 rpm for 30 seconds, followed by loosening. This operation was repeated four times and then the resultant was air-dried once. Next, the resultant was heated in a hot air circulating oven at a temperature of 120° C. for 2 hours and then cooled, thereby obtaining treated filler A-3, the surface of which had been treated with alkoxysilane 2.

### (Production Example A-4)

Except for using filler A-4 instead of filler A-3, multiplying 100 parts by mass of filler A-4 by the specific surface area of filler A-4, dividing the product by the minimum coating area (226 m²/g) of alkoxysilane 2 to give 0.22 parts by mass, weighing and adding 0.22 parts by mass of alkoxysilane 2 as the content of alkoxysilane 2, adding 5 parts by mass of ethanol with respect to 100 parts by mass of filler A-4, and then adding water in an amount (0.11 parts by mass) half the value obtained by multiplying 100 parts by mass of filler A-4 by the specific surface area of filler A-4, and then dividing the product by the minimum coating area of alkoxysilane 2 to obtain a chemical agent, and then adding the chemical agent to filler A-4, treated filler A-4, the surface of which had been treated with alkoxysilane 2, was obtained in the same manner as in production Example A-3.

### <Surface Treatment of Metal Nitride>

Surface treatment of metal nitride was performed in Production Examples B-1 and B-2.

### (Production Example B-1 and B-2)

With the use of a vacuum desiccator that was made of acrylic resin with a plate thickness of 20 mm, had the internal dimensions of 260 mm×260 mm×100 mm, and had a structure vertically divided into three, the upper, the middle and the lower spaces, with the use of partitions having through holes, filler B-1 and filler B-2 were each spread uniformly in an amount of 200 g each over an aluminum stainless steel tray in the upper space and then left to stand. Next, in the lower space of the vacuum desiccator, 10 g of siloxane compound 1 put into a Petri dish made of glass was placed and left to stand. Thereafter, the vacuum desiccator was closed and heated in an oven at 80° C. for 30 hours. The operation was performed while taking safety countermeasures such that the hydrogen gas generated by the reaction was released through a release valve attached to the vacuum desiccator. Next, a sample taken out of the desiccator was put into a crucible made of alumina, and then filler B-1 and filler B-2 with D4H adhered thereto were heated at 700° C. for 3 hours in the atmosphere, thereby obtaining silicon-containing oxide-coated aluminum nitrides, silicon-containing oxide-coated aluminum nitrides B-1 and B-2.

### (Production Example B-3)

With the use of a vacuum desiccator that was made of acrylic resin with a plate thickness of 20 mm, had the internal dimensions of 260 mm×260 mm×100 mm, and had a structure vertically divided into three, the upper, the middle and the lower spaces, with the use of partitions having through holes, 200 g of filler B-3 was spread uniformly over an aluminum stainless steel tray in the upper space, and then left to stand. Next, in the lower space of the vacuum desiccator, 10 g of siloxane compound 1 put into a Petri dish made of glass was placed and left to stand. Thereafter, the vacuum desiccator was closed and heated in an oven at 80° C. for 30 hours. The operation was performed while taking safety countermeasures such that the hydrogen gas generated by the reaction was released through a release valve attached to the vacuum desiccator. Next, a sample taken out of the desiccator was put into a crucible made of alumina, and then filler B-3 with D4H adhered thereto was heated at 800° C. for 3 hours in the atmosphere, thereby obtaining a silicon-containing oxide-coated aluminum nitride, silicon-containing oxide-coated aluminum nitride B-3.

### Example 1

85 parts by mass of addition-type silicone resin 1, 15 parts by mass of polysiloxane compound 1, 400 parts by mass of treated filler A-1, and 500 parts by mass of treated filler A-2 were put into a rotation/revolution mixer (available from THINKY CORPORATION, product name: ARV-310P), and then the mixture was mixed and stirred at a rotational speed of 2,000 rpm for 30 seconds under reduced pressure. Subsequently, the mixture was cooled to room temperature (25° C.), 800 parts by mass of silicon-containing oxide-coated aluminum nitride B-1 was put into the mixture, and then the mixture was mixed and stirred at a rotational speed of 2,000 rpm for 30 seconds, thereby obtaining the thermally conductive composition of Example 1.

### Examples 2 to 4 and Comparative Examples 1 and 2

Except for changing the types and the amounts to be mixed of components as described in Table 1, the thermally conductive compositions of Examples 2 to 4 and Comparative Examples 1 and 2 were obtained in the same manner as in Example 1.

### Example 5

85 parts by mass of condensation-type silicone resin 1, 15 parts by mass of polysiloxane compound 1, 520 parts by mass of filler A-5, and 520 parts by mass of filler A-6 were dried in an oven at a temperature of 100° C. for 30 minutes, and then stirred with a rotation/revolution mixer (available from THINKY CORPORATION, product name: ARV-310P) at a rotational speed of 2,000 rpm for 30 seconds. The mixture was cooled to room temperature (25° C.), 4 parts by mass of cross-linking agent 2 was added, and then the mixture was stirred for defoaming with a rotation/revolution mixer at a rotational speed of 2,000 rpm for 30 seconds. The mixture was cooled to room temperature (25° C.), 4 parts by mass of catalyst 2 (TC-100) was further added, and then the mixture was stirred for defoaming with a rotation/revolution mixer at a rotational speed of 2,000 rpm for 30 seconds, thereby obtaining the thermally conductive composition of Example 5.

### Examples 6 to 15 and Comparative Examples 3 to 9

Except for changing the types and the amounts to be mixed of components as described in Tables 2 to 4, the thermally conductive composition of each of Examples and Comparative Examples was obtained in the same manner as in Example 5.

### Example 16

80 parts by mass of peroxide-type silicone resin 1, 20 parts by mass of polysiloxane compound 2, 200 parts by mass of treated filler A-3, 250 parts by mass of treated filler A-4, 2 parts by mass of additive (ferrosoferric oxide), and 5 parts by mass of organic peroxide (TC-1) were put into a rotation/revolution mixer (available from THINKY CORPORATION, product name: ARV-310P), and then stirred and mixed at a rotational speed of 2,000 rpm for 30 seconds under reduced pressure. Subsequently, the mixture was cooled to room temperature (25° C.), 400 parts by mass of silicon-containing oxide-coated aluminum nitride B-2 was added to the mixture, and then the mixture was stirred for defoaming at a rotational speed of 2,000 rpm for 30 seconds, thereby obtaining the thermally conductive composition of Example 16.

### Example 17 and Comparative Examples 10 to 12>

Except for changing the types and the amounts to be mixed of components as described in Table 5, the thermally conductive composition of each of Examples and Comparative Examples was obtained in the same manner as in Example 16.

In addition, in Comparative Example 12, a polysiloxane compound having at least one hydroxy group not directly bound to a silicon atom at an end was not contained, so that the viscosity of the composition was not sufficiently lowered and filling with the thermally conductive filler (mixing with the thermally conductive filler) could not be performed.

### [Preparation of Test Piece (Cured Product)]

### (1) Cured Products of Thermally Conductive Compositions of Examples 1 to 4, and Comparative Examples 1 and 2

The defoamed thermally conductive composition was poured onto a 0.1-mm thick polyester film subjected to mold release treatment with fluorine, and then the resultant was covered with a 0.1-mm thick polyester film without allowing aeration, formed using a mill roll, cured at 100° C. for 15 minutes, and then left to stand at room temperature (23° C.) for one day, thereby preparing a 2-mm thick sheet. The 2-mm thick sheet was cut into strips with a width of 20 mm, and 3 pieces thereof were layered to form each test piece (length of 80 mm, width 20 mm, thickness of 6 mm) of Example and Comparative Example.

### (2) Cured Products of Thermally Conductive Compositions of Examples 5 to 15, and Comparative Examples 3 to 9

A 0.1-mm thick polyester film subjected to mold release treatment with fluorine was placed in a mold with a diameter of 45 mm and a thickness of 6 mm. The defoamed thermally conductive composition was poured into the mold without allowing aeration, the surface was leveled with a spatula, and then the resultant was left for 1 week in a thermostatic chamber at a temperature of 23±2° C. and humidity of 50±10% RH, thereby obtaining each test piece (diameter of 45 mm and thickness of 6 mm) of Example and Comparative Example.

### (3) Cured Products of Thermally Conductive Compositions of Examples 16 and 17, and Comparative Examples 10 to 12

A 0.1-mm thick polyester film subjected to mold release treatment with fluorine was placed in a mold with a diameter of 45 mm and a thickness of 6 mm. The defoamed thermally conductive composition was poured into the mold without allowing aeration, and then a 0.1-mm thick polyester film was placed on the resultant without allowing aeration. The resultant was placed between aluminum plates, subjected to primary vulcanization with a press at 120° C. for 30 minutes at 0.5 MPa, and then subjected to secondary vulcanization in a hot air circulating oven at a temperature of 200° C. for 4 hours, thereby obtaining each test piece (diameter of 45 mm and thickness of 6 mm) of Example and Comparative Example.

### [Evaluation of Measurement]

The properties of the thermally conductive compositions and the test pieces; that is, the cured products thereof, obtained in each Example and Comparative Example were measured under measurement conditions shown below. Tables 1 to 5 show the results.

### (1) Viscosity

The viscosity of each thermally conductive composition immediately after production (up to 5 minutes after production) was measured according to JIS K7210:2014 using a flow viscometer (GFT-100EX, available from SHIMADZU CORPORATION) under conditions of a temperature of 30° C., a die hole diameter (diameter) of 1.0 mm and a test force of 40 (weight: 7.8 kg).

### (2) Hardness

Regarding test pieces that were cured products of the thermally conductive compositions obtained in Examples 1 to 4, and Comparative Examples 1 and 2, Asker C hardness was measured according to JIS K7312:1996 using a durometer (product name: ASKER Durometer Type C, available from KOBUNSHI KEIKI CO., LTD.).

Regarding test pieces that were cured products of the thermally conductive compositions obtained in Examples 5 to 17, and Comparative Examples 3 to 12, Asker A hardness was measured according to JIS K7312:1996 using a durometer (product name: ASKER Durometer Type A, available from KOBUNSHI KEIKI CO., LTD.).

### (3) Thermal Conductivity

The thermal conductivity of each of the above test pieces was measured according to IS022007-2 by a hot-disk method using a thermophysical property measuring device (available from Kyoto Electronics Manufacturing Co., Ltd., product name TPS 2500 S).

### (4) Tack-Free Time

A 0.1-mm thick polyester film subjected to mold release treatment with fluorine was prepared, and then placed in a mold with a diameter of 45 mm and a thickness of 6 mm. The defoamed thermally conductive composition was poured into the mold without allowing aeration, the surface was then leveled with a spatula, the resultant was then placed in a thermostatic chamber at a temperature of 23±2° C. and humidity of 50±10% RH, and then the time required for the surface to be tack-free was measured every 15 minutes or every 5 minutes.

Note that the tack-free time is an index of quick drying properties, such that the longer the tack-free time, the slower the reaction rate.

### (5) Consistency

The consistency of each thermally conductive resin composition is a penetration with a ¼ cone described in JIS K2220:2013, and was measured using an automatic penetration tester (available from RIGO Co., Ltd., RPM-101).

TABLE 1

| | | | | | Example | Example | Example | Example | Comparative | Comparative |
|---|---|---|---|---|---|---|---|---|---|---|
| | | | | Unit | 1 | 2 | 3 | 4 | Example 1 | Example 2 |
| Composition | Resin | Liquid silicone | Addition-type | Parts by | 85 | 80 | 75 | 70 | 100 | 80 |
| | composition | resin | silicone resin 1 | mass | | | | | | |
| | | Polysiloxane | Polysiloxane | | 15 | 20 | 25 | 30 | — | — |
| | | compound | compound 1^{*1} | | | | | | | |
| | | | Polysiloxane | | — | — | — | — | — | 20 |
| | | | compound 3^{*2} | | | | | | | |

| | | | | | | | | |
|---|---|---|---|---|---|---|---|---|
| | Liquid silicone resin/ | — | 85/15 | 80/20 | 75/25 | 70/30 | — | — |
| | Polysiloxane compound ^{*3} | | | | | | | |
| Thermally | Treated filler A-1 | Parts by | 400 | 400 | 400 | 400 | 400 | 400 |
| conductive | Treated filler A-2 | mass | 500 | 500 | 500 | 500 | 500 | 500 |
| filler | Silicon-containing oxide- | | 800 | 800 | 800 | 800 | 800 | 800 |
| | coated aluminum nitride B-1 | | | | | | | |
| | Total content | | 1700 | 1700 | 1700 | 1700 | 1700 | 1700 |

| | | | | | | | | |
|---|---|---|---|---|---|---|---|---|
| Evaluation | Viscosity | mPa · s | 481 | 801 | 805 | 806 | 960 | 960 |
| | Hardness (Asker C hardness) | — | 51 | 48 | 42 | 37 | 66 | 61 |
| | Thermal conductivity | W/m · k | 7.35 | 7.41 | 7.32 | 7.31 | 7.30 | 7.29 |

^{*1}Polysiloxane compound having two hydroxy groups not directly bound to a silicon atom at an end, and having no vinyl group
^{*2}Polysiloxane compound having no hydroxy group not directly bound to a silicon atom at an end, and having no vinyl group
^{*3} Polysiloxane compound having at least one hydroxy group not directly bound to a silicon atom at an end, and having no vinyl group

TABLE 2

| | | | | | | | | | Com- | Com- | Com- |
|---|---|---|---|---|---|---|---|---|---|---|---|
| | | | | | Example | Example | Example | Example | parative | parative | parative |
| | | | | Unit | 5 | 6 | 7 | 8 | Example 3 | Example 4 | Example 5 |
| Composition | Resin | Liquid | Condensation- | Parts | 85 | 80 | 75 | 70 | 100 | 95 | 90 |
| | composition | silicone | type silicone | by | | | | | | | |
| | | resin | resin 1 | mass | | | | | | | |
| | | Polysiloxane | Polysiloxane | | 15 | 20 | 25 | 30 | 0 | 5 | 10 |
| | | compound | compound 1^{*4} | | | | | | | | |
| | | Liquid silicone | | — | 85/15 | 80/20 | 75/25 | 70/30 | 100/0 | 95/5 | 90/10 |
| | | resin/Polysiloxane | | | | | | | | | |
| | | compound ^{*5} | | | | | | | | | |
| | Thermally | Filler A-5 | | Parts | 520 | 520 | 520 | 520 | 520 | 520 | 520 |
| | conductive | Filler A-6 | | by | 520 | 520 | 520 | 520 | 520 | 520 | 520 |
| | filler | Total content | | mass | 1040 | 1040 | 1040 | 1040 | 1040 | 1040 | 1040 |
| | Plasticizer | Plasticizer 1 | | | — | — | — | — | — | — | — |
| | Cross- | Cross-linking agent 2 | | | 4 | 4 | 4 | 4 | 4 | 4 | 4 |
| | linking | | | | | | | | | | |
| | agent | | | | | | | | | | |
| | Catalyst | Catalyst 2 | | | 4 | 4 | 4 | 4 | 4 | 4 | 4 |
| Evaluation | Tack-free time | | | Minute | 10 | 10 | 10 | 10 | 5 | 5 | 5 |
| | Consistency (1/4 cone) | | | — | 329 | 337 | 335 | 333 | 287 | 287 | 287 |
| | Hardness (Asker A hardness) | | | — | 82 | 74 | 70 | 42 | 90 | 88 | 88 |
| | Thermal conductivity | | | W/m · k | 2.91 | 2.87 | 2.86 | 2.85 | 2.94 | 2.93 | 2.91 |
| | | | | | | | | | | | Com- |
| | | | | | | | Example | Example | Example | Example | parative |
| | | | | | | Unit | 9 | 10 | 11 | 12 | Example 6 |

| | | | | | | | | | |
|---|---|---|---|---|---|---|---|---|---|
| Composition | Resin | Liquid | Condensation- | Parts | 65 | 60 | 55 | 50 | 80 |
| | composition | silicone | type silicone | by | | | | | |
| | | resin | resin 1 | mass | | | | | |
| | | Polysiloxane | Polysiloxane | | 35 | 40 | 45 | 50 | — |
| | | compound | compound 1^{*4} | | | | | | |

| | | | | | | | |
|---|---|---|---|---|---|---|---|
| | Liquid silicone | — | 65/35 | 60/40 | 55/45 | 50/50 | — |
| | resin/Polysiloxane | | | | | | |
| | compound ^{*5} | | | | | | |
| Thermally | Filler A-5 | Parts | 520 | 520 | 520 | 520 | 520 |
| conductive | Filler A-6 | by | 520 | 520 | 520 | 520 | 520 |
| filler | Total content | mass | 1040 | 1040 | 1040 | 1040 | 1040 |
| Plasticizer | Plasticizer 1 | | — | — | — | — | 20 |
| Cross- | Cross-linking agent 2 | | 4 | 4 | 4 | 4 | 4 |
| linking | | | | | | | |
| agent | | | | | | | |
| Catalyst | Catalyst 2 | | 4 | 4 | 4 | 4 | 4 |

| | | | | | | | |
|---|---|---|---|---|---|---|---|
| Evaluation | Tack-free time | Minute | 10 | 15 | 30 | 30 | 5 |
| | Consistency (1/4 cone) | — | 342 | 340 | 352 | 358 | 298 |
| | Hardness (Asker A hardness) | — | 32 | 28 | 10 | 7 | 74 |
| | Thermal conductivity | W/m · k | 2.88 | 2.89 | 2.92 | 2.91 | 2.87 |

^{*4}Polysiloxane compound having two hydroxy groups not directly bound to a silicon atom at an end, and having no vinyl group
^{*5} Polysiloxane compound having at least one hydroxy group not directly bound to a silicon atom at an end, and having no vinyl group

TABLE 3

| | | | | | Example | Example | Comparative |
|---|---|---|---|---|---|---|---|
| | | | | Unit | 13 | 14 | Example 7 |
| Composition | Resin | Liquid silicone resin | Condensation-type silicone | Parts | 55 | 50 | 40 |
| | composition | | resin 1 | by mass | | | |
| | | Polysiloxane compound | Polysiloxane compound 1^{*6} | | 45 | 50 | 60 |

| | | | | | |
|---|---|---|---|---|---|
| | Liquid silicone resin/Polysiloxane compound ^{*7} | — | 55/45 | 50/50 | 40/60 |
| Thermally | Filler A-5 | Parts | 520 | 520 | 520 |
| conductive filler | Filler A-6 | by mass | 520 | 520 | 520 |
| | Total content | | 1040 | 1040 | 1040 |
| Cross-linking | Cross-linking agent 1 | | 4 | 4 | 4 |
| agent | | | | | |
| Catalyst | Catalyst 1 | | 4 | 4 | 4 |

| | | | | | |
|---|---|---|---|---|---|
| Evaluation | Tack-free time | Minute | 15 | 15 | 30 |
| | Consistency (1/4 cone) | — | 352 | 358 | 368 |
| | Hardness (Asker A hardness) | — | 82 | 83 | 37 |
| | Thermal conductivity | W/m · k | 2.93 | 2.91 | 2.91 |

^{*6}Polysiloxane compound having two hydroxy groups not directly bound to a silicon atom at an end, and having no vinyl group
^{*7} Polysiloxane compound having at least one hydroxy group not directly bound to a silicon atom at an end, and having no vinyl group

TABLE 4

| | | | | | Example | Comparative | Comparative |
|---|---|---|---|---|---|---|---|
| | | | | Unit | 15 | Example 8 | Example 9 |
| Composition | Resin | Liquid silicone resin | Condensation-type silicone | Parts | 80 | 80 | 100 |
| | composition | | resin 1 | by mass | | | |
| | | Polysiloxane compound | Polysiloxane compound 1^{*8} | | 20 | — | — |

| | | | | | |
|---|---|---|---|---|---|
| | Liquid silicone resin/Polysiloxane compound ^{*9} | — | 80/20 | — | — |
| Thermally | Filler A-3 | Parts | 432 | 432 | 432 |
| conductive filler | Filler A-4 | by mass | 540 | 540 | 540 |
| | Silicon-containing oxide-coated aluminum nitride B-3 | | 864 | 864 | 864 |
| | Total content | | 972 | 972 | 972 |
| Plasticizer | Plasticizer 1 | | — | 20 | — |
| Cross-linking | Cross-linking agent 2 | | 4 | 4 | 4 |
| agent | | | | | |

| | | | | | |
|---|---|---|---|---|---|
| Evaluation | Tack-free time | Minute | 10 | 5 | 5 |
| | Consistency (1/4 cone) | — | 181 | 159 | 91 |
| | Hardness (Asker A hardness) | — | 95 | 95 | 98 |
| | Thermal conductivity | W/m · k | 8.15 | 8.21 | 8.21 |

^{*8}Polysiloxane compound having two hydroxy groups not directly bound to a silicon atom at an end, and having no vinyl group
^{*9} Polysiloxane compound having at least one hydroxy group not directly bound to a silicon atom at an end, and having no vinyl group

TABLE 5

| | | | | | | | Comparative | Comparative | Comparative |
|---|---|---|---|---|---|---|---|---|---|
| | | | | | Example | Example | Example | Example | Example |
| | | | | Unit | 16 | 17 | 10 | 11 | 12 |
| Composition | Resin | Liquid | Peroxide-type | Parts by | 80 | 80 | 100 | 80 | 100 |
| | composition | silicone resin | silicone resin 1 | mass | | | | | |
| | Thermally | Polysiloxane | Polysiloxane | | 20 | 20 | — | — | — |
| | conductive filler | compound | compound 2^{*10} | | | | | | |
| | | | Polysiloxane | | — | — | — | 20 | — |
| | | | compound 4^{*11} | | | | | | |

| | | | | | | | |
|---|---|---|---|---|---|---|---|
| | Liquid silicone resin/ | — | 80/20 | 80/20 | — | — | — |
| | Polysiloxane compound ^{*12} | | | | | | |
| | Treated filler A-3 | Parts by | 200 | 300 | 200 | 200 | 300 |
| | Treated filler A-4 | mass | 250 | 375 | 250 | 250 | 375 |
| | Silicon-containing oxide-coated | | 400 | 600 | 400 | 400 | 600 |
| | aluminum nitride B-2 | | | | | | |
| | Total content | | 850 | 1275 | 850 | 850 | 1275 |
| Additive | Ferrosoferric oxide | | 2 | 2 | 2 | 2 | 2 |
| Organic peroxide | TC-1 | | 5 | 5 | 5 | 5 | 5 |

| | | | | | | | |
|---|---|---|---|---|---|---|---|
| Evaluation | Viscosity | Pa · s | 253 | 322 | 534 | 229 | — |
| | Hardness (Asker A hardness) | — | 85 | 95 | 91 | 90 | — |
| | Thermal conductivity | W/m · k | 3.04 | 4.96 | 3.05 | 3.05 | — |

^{*10}Polysiloxane compound having two hydroxy groups not directly bound to a silicon atom at an end, and having no vinyl group
^{*11}Polysiloxane compound having no hydroxy group not directly bound to a silicon atom at an end, and having no vinyl group
^{*12} Polysiloxane compound having at least one hydroxy group not directly bound to a silicon atom at an end, and having no vinyl group

Comparison of Examples and Comparative Examples reveals that the thermally conductive composition contains the polysiloxane compound having a hydroxy group at an end, so that the viscosity immediately after production is low and a cured product having appropriate hardness is obtained.

1. A thermally conductive composition comprising a resin composition and a thermally conductive filler, wherein
the resin composition comprises a liquid silicone resin having a viscosity ranging from 20 mPa·s to 200,000,000 mPa·s at 25° C. as measured according to JIS Z8803:2011 and a polysiloxane compound having at least one hydroxy group not directly bound to a silicon atom at an end, and having no vinyl group,
the mass ratio of the liquid silicone resin to the polysiloxane compound [the liquid silicone resin/the polysiloxane compound] is 50/50 or more and less than 90/10,
the content of the thermally conductive filler ranges from 300 parts by mass to 5,000 parts by mass with respect to 100 parts by mass of the resin composition, and
a cured product of the thermally conductive composition has a thermal conductivity of 1.0 W/mk or more as measured according to ISO22007-2.

2. The thermally conductive composition according to claim 1, wherein the polysiloxane compound has two or more hydroxy groups not directly bound to a silicon atom, at one of the ends of the main chain constituting the polysiloxane compound.

3. The thermally conductive composition according to claim 1, wherein the polysiloxane compound is represented by general formula (1) below: 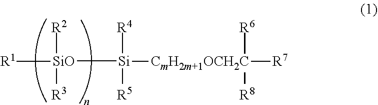
wherein R¹ is an alkyl group having 1 to 18 carbon atoms, or a phenyl group, R² to R⁵ are each independently an alkyl group having 1 to 18 carbon atoms, or a phenyl group, R⁶ and R⁸ are each independently a hydrogen atom, a hydroxymethyl group, or a hydroxyethyl group, R⁷ is an alkyl group having 1 to 3 carbon atoms, a hydroxy group, or a phenyl group, n is 5 to 250, m is 1 to 20, and when there are a plurality of R² and R^{3,} the plurality of R² and R³ are the same or different.

4. The thermally conductive composition according to claim 3, wherein R¹ is an alkyl group having 1 to 18 carbon atoms.

5. The thermally conductive composition according to claim 3, wherein R⁶ and R⁸ are each independently a hydroxymethyl group or a hydroxyethyl group.

6. The thermally conductive composition according to claim 1, wherein the liquid silicone resin is at least one selected from the group consisting of an addition reaction curable-type silicone resin, a condensation reaction curable-type silicone resin, and an organic peroxide curable-type silicone resin.

7. The thermally conductive composition according to claim 1, wherein the content of the thermally conductive filler is 3,000 parts by mass or less with respect to 100 parts by mass of the resin composition.

8. The thermally conductive composition according to claim 1, wherein the liquid silicone resin has a viscosity of 10,000,000 mPa·s or less at 25° C. as measured according to JIS Z8803:2011.

9. The thermally conductive composition according to claim 1, which is used for a semiconductor package.

10. A method for producing a thermally conductive composition, wherein the thermally conductive composition according to claim 1 is obtained by mixing the liquid silicone, the polysiloxane compound, and the thermally conductive filler.

11. A method for using a thermally conductive composition, comprising mixing a liquid silicone, a polysiloxane compound and a thermally conductive filler, and then filling a container with the mixture for use.

12. A method for using a thermally conductive composition, comprising filling a container with a liquid silicone, a polysiloxane compound, and a thermally conductive filler, respectively, for use.
